(19) United States
(12) Patent Application Publication
(10) Pub. No.: US 2026/0311039 A1
(43) Pub. Date: Oct. 8, 2026

(54) AUTOMATED MANAGEMENT OF CONFIGURATION DRIFT FOR MACHINE LEARNING MODELS

(71) Applicant: Dell Products L.P., Round Rock, TX (US)

(72) Inventors: Ian Roche, Glanmire (IE); Colin Stewart Byrne, Newmarket on Fergus (IE); Fabricio Almeida Bronzati, Sao Paulo (BR)

(21) Appl. No.: 19/171,781

(22) Filed: Apr. 7, 2025

(51) Int. Cl. G06N 20/00; G06F 8/71

(52) U.S. Cl. CPC G06N 20/00; G06F 8/71

(57) ABSTRACT

An apparatus comprises at least one processing device configured to monitor performance metrics associated with execution of a machine learning model deployed on an information technology asset, to determine configuration information characterizing a current configuration for the information technology asset, and to generate, utilizing performance prediction models that take as input the determined configuration information, predicted performance metrics associated with execution of the machine learning model utilizing the current configuration of the information technology asset. The at least one processing device is further configured to modify, in response to determining utilizing the monitored and predicted performance metrics that the execution of the machine learning model deployed on the information technology asset is experiencing a configuration drift-induced performance issue, at least one of (i) the current configuration of the information technology asset and (ii) the machine learning model deployed on the information technology asset.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering.

### SUMMARY

Illustrative embodiments of the present disclosure provide techniques for automated management of configuration drift for machine learning models deployed on information technology assets.

In one embodiment, an apparatus comprises at least one processing device comprising a processor coupled to a memory. The at least one processing device is configured to monitor one or more performance metrics associated with execution of a machine learning model deployed on an information technology asset, to determine configuration information characterizing a current configuration for the information technology asset on which the machine learning model is deployed, and to generate, utilizing one or more performance prediction models that take as input the determined configuration information, one or more predicted performance metrics associated with execution of the machine learning model utilizing the current configuration of the information technology asset. The at least one processing device is also configured to determine, utilizing the one or more predicted performance metrics and the monitored one or more performance metrics, whether the execution of the machine learning model deployed on the information technology asset is experiencing a configuration drift-induced performance issue. The at least one processing device is further configured to modify, in response to determining that the execution of the machine learning model deployed on the information technology asset is experiencing the configuration drift-induced performance issue, at least one of (i) the current configuration of the information technology asset and (ii) the machine learning model deployed on the information technology asset.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for automated management of configuration drift for machine learning models deployed on information technology assets in an illustrative embodiment.

FIG. 2 is a flow diagram of an exemplary process for automated management of configuration drift for machine learning models deployed on information technology assets in an illustrative embodiment.

FIG. 3 shows a system configured for detecting configuration drift-induced performance issues associated with execution of machine learning models deployed on information technology assets in an illustrative embodiment.

FIG. 4 shows a process flow for detecting configuration drift-induced performance issues associated with execution of machine learning models deployed on information technology assets in an illustrative embodiment.

FIG. 5 shows a table of monitored performance metrics and configuration information for machine learning models deployed on information technology assets in an illustrative embodiment.

FIG. 6 shows a plot of throughput as a function of concurrency for evaluating performance of a machine learning model deployed on an information technology asset in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

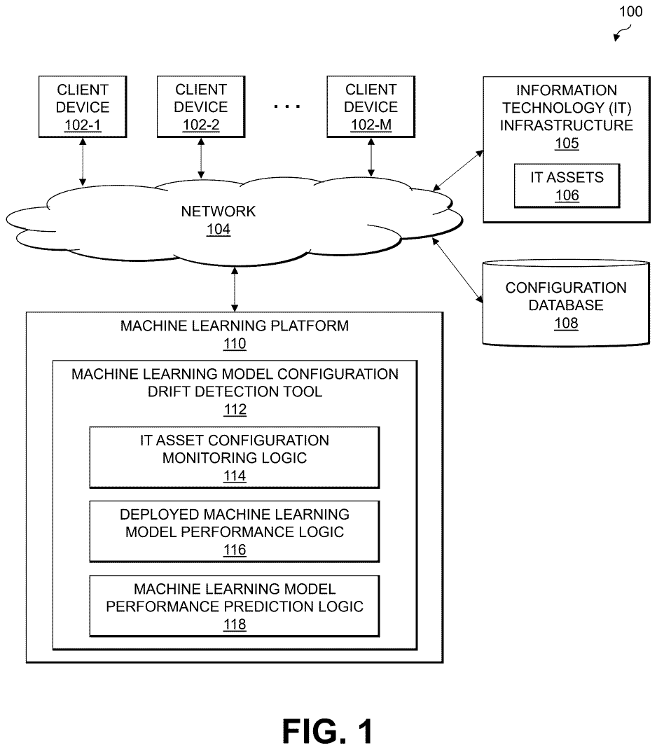

FIG. 1 shows an information processing system 100 configured in accordance with an illustrative embodiment. The information processing system 100 is assumed to be built on at least one processing platform and provides functionality for automated management of configuration drift for machine learning models deployed on information technology (IT) assets. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a configuration database 108, and a machine learning platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the machine learning platform 110 is used for an enterprise system. For example, an enterprise may subscribe to or otherwise utilize the machine learning platform 110 for monitoring and managing artificial intelligence (AI) and machine learning (ML) models, such as large language models (LLMs), which are deployed on IT assets 106 of the IT infrastructure 105. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The configuration database 108 is configured to store and record various information that is utilized by the machine learning platform 110. Such information may include, for example, LLMs or other AI/ML models, hardware and software configurations of the IT assets 106 of the IT infrastructure 105 on which the LLMs or other AI/ML models are deployed, performance data for deployed LLMs or other AI/ML models, performance prediction models for predicting how LLMs or other AI/ML models are expected to perform on different hardware and software configurations, etc. The configuration database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the machine learning platform 110, as well as to support communication between the machine learning platform 110 and other related systems and devices not explicitly shown.

The machine learning platform 110 may be provided as a cloud service that is accessible by one or more of the client devices 102 to allow users thereof to perform management and monitoring of LLMs or other AI/ML models which are deployed on IT assets 106 of the IT infrastructure 105 for an enterprise, organization or other entity. In some embodiments, the client devices 102 are utilized by members of the same enterprise, organization or other entity that operates the machine learning platform 110. In other embodiments, the client devices 102 are utilized by members of one or more enterprises, organizations or other entities different than the enterprise, organization or other entity that operates the machine learning platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the configuration database 108 and the machine learning platform 110 regarding deployment of LLMs or other AI/ML models on the IT assets 106 of the IT infrastructure 105, performance data for deployed LLMs or other AI/ML models, configuration changes for the IT assets 106 of the IT infrastructure on which the LLMs or other AI/ML models are deployed. It should be noted that a “host agent” as this term is generally used herein may comprise an automated entity, such as a software entity running on a processing device. Accordingly, a host agent need not be a human entity.

The machine learning platform 110 in the FIG. 1 embodiment is assumed to be implemented using at least one processing device. Each such processing device generally comprises at least one processor and an associated memory, and implements one or more functional modules or logic for controlling certain features of the machine learning platform 110. In the FIG. 1 embodiment, the machine learning platform 110 implements a machine learning model configuration drift detection tool 112. The machine learning model configuration drift detection tool 112 comprises IT asset configuration monitoring logic 114, deployed machine learning model performance logic 116, and machine learning model performance prediction logic 118. The IT assets configuration monitoring logic 114 is configured to monitor for changes and updates to the hardware and/or software configuration of ones of the IT assets 106 of the IT infrastructure 105 on which LLMs or other AI/ML models are deployed. In some cases, this includes monitoring for changes and updates to the LLMs or other AI/ML models which are deployed. The deployed machine learning model performance logic 116 is configured to monitor the performance (e.g., throughput, latency, time to first token (TTFT), etc.) of the LLMs or other AI/ML models which are deployed on the IT assets 106 of the IT infrastructure 105.

The machine learning model performance prediction logic 118 is configured to utilize one or more performance prediction models to predict what the performance of a deployed LLM or other AI/ML model is expected to be, given the hardware and software configuration of the IT assets 106 of the IT infrastructure 105 on which the LLM or other AI/ML model has been deployed. The predicted performance may include predicting various performance metrics, such as throughput, latency, TTFT, etc. The machine learning model performance prediction logic 118 is configured to periodically update the performance predictions, so as to track performance “drift” or other performance anomalies for the deployed LLMs or other AI/ML models. On detecting any such performance anomalies, the machine learning model configuration drift detection tool 112 can take various remedial actions, including: generating and delivering notifications to users (e.g., of client device 102) that are responsible for operating, managing and utilizing the LLMs or other AI/ML models deployed on the IT assets 106 of the IT infrastructure 105; performing root cause analysis (RCA) of the performance anomalies (e.g., to detect changes in the deployed LLMs or other AI/ML models that are causing the performance anomalies, to detect changes in the hardware and/or software configurations of the IT assets 106 of the IT infrastructure 105 on which the LLMs or other AI/ML models are deployed which are causing the performance anomalies, to detect changes in the IT infrastructure 105 environment in which the IT assets 106 operate which are causing the performance anomalies, such as changes in air flow or other heating and cooling conditions of the operating environment, etc.); rolling back detected changes in the deployed LLMs or other AI/ML models and/or the hardware and software configurations of the IT assets 106 of the IT infrastructure 105 which are determined to be likely causes of the performance anomalies; etc.

At least portions of the machine learning model configuration drift detection tool 112, the IT asset configuration monitoring logic 114, the deployed machine learning model performance logic 116 and the machine learning model performance prediction logic 118 may be implemented at least in part in the form of software that is stored in memory and executed by a processor.

It is to be appreciated that the particular arrangement of the client devices 102, the IT infrastructure 105, the configuration database 108 and the machine learning platform 110 illustrated in the FIG. 1 embodiment is presented by way of example only, and alternative arrangements can be used in other embodiments. As discussed above, for example, the machine learning platform 110 (or portions of components thereof, such as one or more of the machine learning model configuration drift detection tool 112, the IT asset configuration monitoring logic 114, the deployed machine learning model performance logic 116 and the machine learning model performance prediction logic 118) may in some embodiments be implemented internal to the IT infrastructure 105.

The machine learning platform 110 and other portions of the information processing system 100, as will be described in further detail below, may be part of cloud infrastructure.

The machine learning platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the configuration database 108 and the machine learning platform 110 or components thereof (e.g., the machine learning model configuration drift detection tool 112, the IT asset configuration monitoring logic 114, the deployed machine learning model performance logic 116 and the machine learning model performance prediction logic 118) may be implemented on respective distinct processing platforms, although numerous other arrangements are possible. For example, in some embodiments at least portions of the machine learning platform 110 and one or more of the client devices 102, the IT infrastructure 105, the IT assets 106 and/or the configuration database 108 are implemented on the same processing platform. A given client device (e.g., 102-1) can therefore be implemented at least in part within at least one processing platform that implements at least a portion of the machine learning platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the configuration database 108 and the machine learning platform 110, or portions or components thereof, to reside in different data centers. Numerous other distributed implementations are possible. The machine learning platform 110 can also be implemented in a distributed manner across multiple data centers.

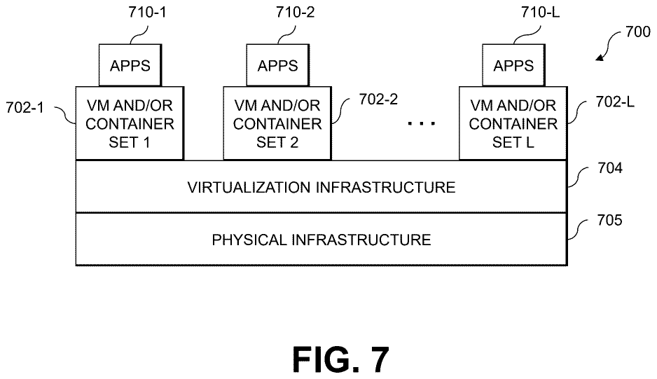

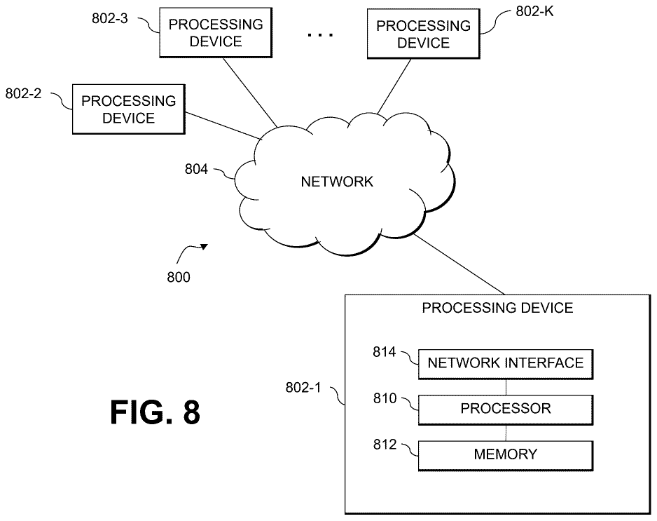

Additional examples of processing platforms utilized to implement the machine learning platform 110 and other components of the information processing system 100 in illustrative embodiments will be described in more detail below in conjunction with FIGS. 7 and 8.

It is to be understood that the particular set of elements shown in FIG. 1 for automated management of configuration drift for machine learning models deployed on IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

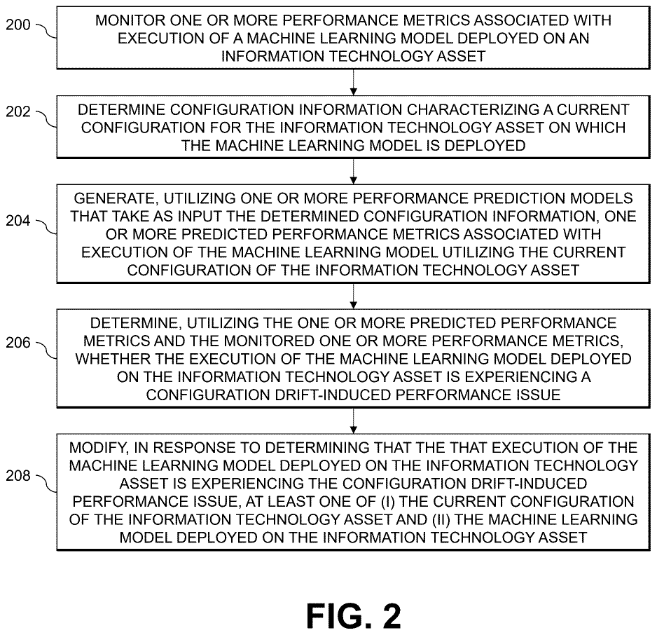

An exemplary process for automated management of configuration drift for machine learning models deployed on IT assets will now be described in more detail with reference to the flow diagram of FIG. 2. It is to be understood that this particular process is only an example, and that additional or alternative processes for automated management of configuration drift for machine learning models deployed on IT assets may be used in other embodiments.

In this embodiment, the process includes steps 200 through 208. These steps are assumed to be performed by the machine learning platform 110 utilizing the machine learning model configuration drift detection tool 112, the IT asset configuration monitoring logic 114, the deployed machine learning model performance logic 116 and the machine learning model performance prediction logic 118. The process begins with step 200, monitoring one or more performance metrics associated with execution of a machine learning model deployed on an IT asset. The machine learning model may comprise an LLM, and step 200 may include monitoring: an average input token performance metric characterizing an average number of input tokens for input prompts applied to the LLM; an average output token performance metric characterizing an average number of output tokens for responses output by the LLM in response to the input prompts; and a TTFT metric characterizing an average time taken to return a first output token in the responses output by the LLM in response to the input prompts.

In step 202, configuration information characterizing a current configuration for the IT asset on which the machine learning model is deployed is determined. Step 202 may include detecting a current hardware and software configuration of the IT asset, detecting at least one of a number and a type of graphics processing units (GPUs) of the IT asset utilized for performing inference using the machine learning model, and/or detecting at least one of a version and a type of machine learning model deployment framework used for executing the machine learning model on the IT asset.

In step 204, one or more predicted performance metrics associated with execution of the machine learning model utilizing the current configuration of the IT asset are generated utilizing one or more performance prediction models that take as input the determined configuration information. The one or more predicted performance metrics may comprise: a throughput metric characterizing an expected throughput associated with execution of the machine learning model utilizing the current configuration of the IT asset; a latency metric characterizing an expected latency associated with execution of the machine learning model utilizing the current configuration of the IT asset; and a TTFT metric charactering an expected TTFT associated with execution of the machine learning model utilizing the current configuration of the IT asset. In some embodiments, steps 200, 202 and 204 are performed periodically, in response to detecting that at least a threshold amount of time has passed since the machine learning model was first deployed on the IT asset, etc.

In step 206, a determination is made, utilizing the one or more predicted performance metrics and the monitored one or more performance metrics, as to whether the execution of the machine learning model deployed on the IT asset is experiencing a configuration drift-induced performance issue. In response to determining that the execution of the machine learning model deployed on the IT asset is experiencing the configuration drift-induced performance issue, at least one of (i) the current configuration of the IT asset and (ii) the machine learning model deployed on the IT asset is modified in step 208. Step 208 may include identifying one or more changes that are potential causes of the configuration drift-induced performance issue and rolling back the identified one or more changes to remediate the configuration drift-induced performance issue. The identified one or more changes may comprise at least one of: a change in a version of the machine learning model that is deployed on the IT asset; a change in hardware resources of the IT asset allocated for executing the machine learning model; a change in software installed on the IT asset; a change in hardware installed in the IT asset; a change in an IT infrastructure environment in which the IT asset operates (e.g., a change in air flow, heating and/or cooling of the IT infrastructure environment); etc.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

As more and more LLMs and other AI/ML models are deployed (e.g., to production environments), there is an ongoing challenge to ensure that the deployed LLMs or other AI/ML models are performing optimally or otherwise in accordance with expected performance levels. While some tools are available for detecting data drift, technical solutions are needed for detecting model drift which factor in features such as library version changes, operating system (OS) changes and other changes in the hardware and software configuration of IT assets on which LLMs or other AI/ML models are deployed (e.g., including changes in which resources are available and/or utilized for running on AI/ML models on IT assets, such as the particular numbers and types of GPUs of the IT assets which are used for performing inference for deployed LLMs or other AI/ML models, etc.), changes in the operating environment of the IT infrastructure (e.g., changes in airflow or other heating and cooling of the data centers or other IT infrastructure environments that host the IT assets on which LLMs or other AI/ML models are deployed), etc. Illustrative embodiments provide technical solutions for analyzing the performance of LLMs and other AI/ML models which are deployed (e.g., in production environments), to detect and remediate potential configuration drift issues.

Tuning the performance of LLMs and other AI/ML models for production deployment is a difficult process. The tuning process is typically performed the first time that a particular model (e.g., an LLM or other AI/ML model) is deployed. It is common that a deployment will have strict performance criteria that must be adhered to. Some examples of performance criteria include: a TTFT response time below a designated threshold (e.g., <50 milliseconds); supporting a designated minimum and/or maximum number of concurrent users (e.g., supporting a maximum of 2000 concurrent users); and ensuring a designated inter-token latency (e.g., <30 ms). In some cases, multiple criteria are considered together, e.g., “I want a TTFT less than 30 ms while supporting 500 concurrent users” using a designated LLM (e.g., a Llama 3.2 70B LLM model). While this can be achieved at launch time, it is very difficult to retain these levels when part of the system (e.g., the IT assets) on which the LLM is deployed undergo changes, or if the deployed LLM changes (e.g., upgrades or updates to a new version). For example, various system configuration changes can impact the performance of an LLM or other AI/ML model such as: the LLM runtime or deployment framework (e.g., NVIDIA® TensorRT™, vLLM, Text Generation Inference (TGI), etc.) that is used, including updates, upgrades or changes in the LLM runtime or deployment framework; GPU driver upgrades; new versions of the LLM or other AI/ML model; hardware issues, including GPU issues; heating and cooling issues; changes to operation system (OS) basic input/output system (BIOS) or firmware; etc. The types of changes that can affect LLM performance are very broad, such that it is extremely difficult to detect performance degradation and its causes.

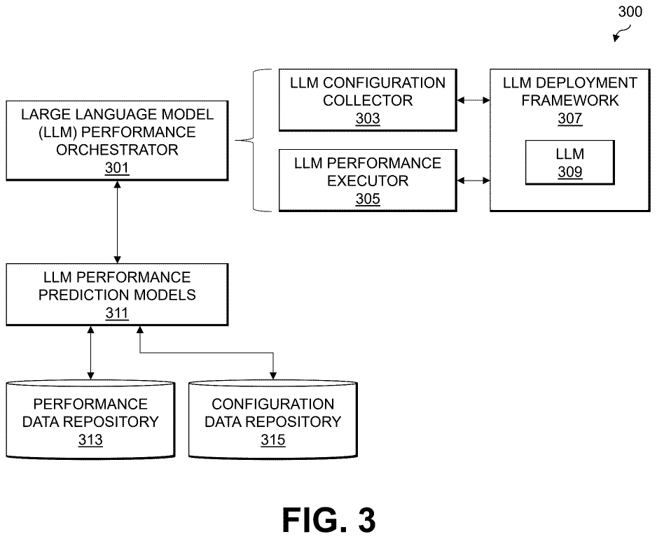

FIG. 3 shows a system 300 configured for detecting and remediating LLM performance drift. The system 300 includes an LLM performance orchestrator 301, an LLM configuration collector 303, an LLM performance executor 305, an LLM 309 deployed utilizing LLM deployment framework 307, LLM performance prediction models 311, a performance data repository 313 and a configuration data repository 315. The LLM performance orchestrator 301 is configured to utilize the LLM configuration collector 303 and the LLM performance executor 305 to inspect or monitor performance of the LLM 309 that is deployed using the LLM deployment framework 307 (e.g., NVIDIA® TensorRT™, vLLM, TGI, etc.). The LLM performance orchestrator 301 utilizes the LLM performance prediction models 311 to generate predictions for various performance criteria (e.g., throughput, TTFT, latency, etc.), for the LLM 309. The LLM performance prediction models 311 may be trained utilizing historical performance data maintained in performance data repository 313 and historical configuration data maintained in configuration data repository 315. The LLM performance prediction models 311 may be trained to some designated threshold accuracy level.

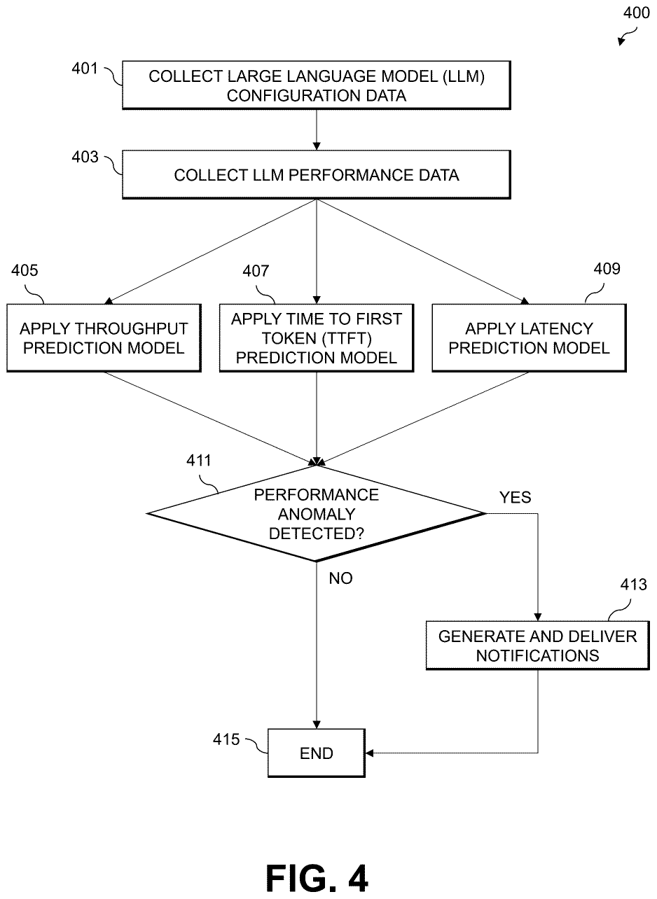

FIG. 4 shows a process flow 400 which may be performed utilizing the system 300. The process flow 400 begins in step 401, where the LLM performance orchestrator 301 collects configuration data from the LLM deployment framework 307 for the LLM 309 deployed therein utilizing the LLM configuration collector 303. In step 403, the LLM performance orchestrator 301 collects performance data for the LLM 309 deployed in the LLM deployment framework 307 utilizing the LLM performance executor 305. In steps 405, 407 and 409, the LLM performance orchestrator 301 applies different ones of the LLM performance prediction models 311 (e.g., where the LLM performance prediction models 311 are trained utilizing historical performance data maintained in the performance data repository 313 and historical configuration data maintained in the configuration data repository 315). More particularly, a throughput prediction model is applied in step 405, a TTFT prediction model is applied in step 407, and a latency prediction model is applied in step 409. If step 411, the LLM performance orchestrator 301 determines whether any of the prediction models detects a performance anomaly (e.g., an error, a configuration drift for the LLM 309, etc.). If a performance anomaly is detected, the process flow 400 proceeds to step 413 where one or more notifications are generated and delivered to various targets (e.g., a user or entity that has deployed the LLM 309 in their production environment, IT support staff responsible for managing the IT assets on which the LLM 309 is deployed in the production environment, etc.). Such notifications may trigger automated actions, such as: rolling back one or more changes in the deployed LLM 309 and/or one or more changes in the configuration of the LLM deployment framework 307 and/or the IT assets on which the LLM 309 is deployed; initiating root cause analysis (RCA) to determine which of the changes in the deployed LLM 309 and/or the configuration of the LLM deployment framework 307 and/or the IT assets on which the LLM 309 is deployed are the cause of the detected performance anomalies; etc. Following step 413, or if no performance anomaly is detected in step 411, the process flow 400 ends in step 415.

It should be noted that, due to the variety of possible configurations of IT assets on which LLMs or other AI/ML models are deployed, as well as the variety of different types of LLMs or other AI/ML models, it is not feasible to have or maintain a complete dataset for all possible scenarios for deployment of an LLM or other AI/ML model. To solve for this, the technical solutions in some embodiments build and utilize a series of regression models that generalize the data and predict results for unseen configurations. The training set utilized for building the LLM performance prediction models 311 includes an aggregation of performance data (e.g., from the performance data repository 313) and configuration data (e.g., from the configuration data repository 315), as the performance of an LLM or other AI/ML model may be directly related to the system configuration that is used for deploying the LLM or other AI/ML model.

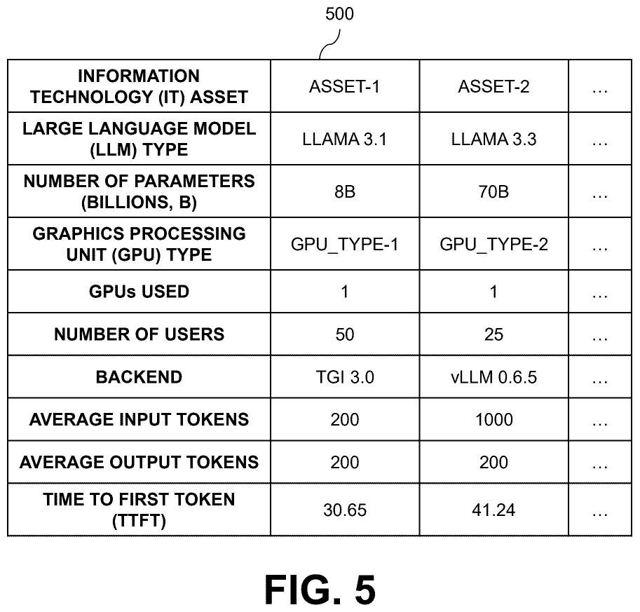

FIG. 5 shows a table 500 including various features which may be used in training and building the LLM performance prediction models 311. The table 500 includes features such as: the IT asset (e.g., server) on which an LLM was deployed; the LLM type or version deployed (e.g., Llama 3.1, Llama 3.3, etc.); the number of parameters used in the deployed LLM (e.g., in billions, B); the GPU type of the IT assets on which the LLMs are deployed; the number of GPUs used on the IT assets on which the LLMs are deployed; the number of users of the deployed LLM; the backend or LLM deployment framework version (e.g., TGI 3.0, vLLM 0.6., etc.); the average input tokens (e.g., for prompts supplied to the deployed LLM); the average output tokens (e.g., for responses to the prompts supplied to the deployed LLM); and the TTFT. It should be noted that the features shown in the table 500 are not exhaustive, and that various other features may be included and used, including: quantization; central processing unit (CPU) type; driver versions; GPU temperature; etc.

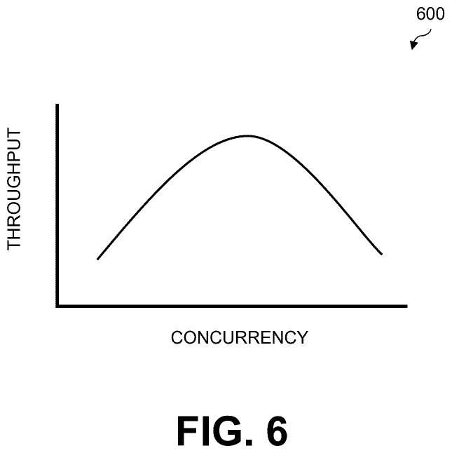

Different ones of the LLM performance prediction models 311 may use different target features (e.g., throughput, inter-token latency, TTFT, etc.). In some embodiments, the LLM performance prediction models 311 leverage polynomial regression. This type of regression is suitable when the relationship between the features is non-linear. For example, in this scenario, it is likely that no change in performance is observed until GPU utilization exceeds a designated threshold level, after which performance degradation can be dramatic. FIG. 6 shows a plot 600 illustrating a visual example of a non-linear predictor (e.g., quadratic, or power of 2) relationship between throughput and concurrency. It should be noted that this is just an example of one feature that is non-linear, others are expected. The general form of polynomial regression is as follows:

$$y = {β}_{0} + {β}_{1} x + {β}_{2} {x}^{2} … + {β}_{n} {x}^{n} + ϵ$$

where y is the dependent variable, x is the independent variable, β₀ . . . βₙ are the coefficients, and ϵ is the error. In some embodiments, the LLM performance prediction models 311 are built using the Python programming language, leveraging the scikit library as a basis. There are various technical challenges, including multiple non-linear relationships which will make the models complex, and that the value of n in βₙ will need to be identified on a case-by-case basis. Because of the complexities, different combinations of polynomial regression models may be tested and evaluated. Various approaches may be used for testing the regression models. For each variation of the model, the Mean Squared Error (MSE) is calculated and used to select the model with the lowest MSE value. The R² value of the features may also be examined to ensure the preferred model is indeed responding to the changes in feature variables versus overfitting. Because of the nature of the data, multiple custom regression models will be created. For example, the LLM performance prediction models 311 may include a throughput prediction model, a latency prediction model and a TTFT prediction model.

An example implementation of the process flow 400 using system 300 will now be described. In this example, a customer deploys the Llama 3.3 8B LLM on a specific server. Various benchmarks are run, and performance and configuration data are gathered using the LLM configuration collector 303 and the LLM performance executor 305. This data is sent to the LLM performance orchestrator 301, which runs such data using the LLM performance prediction models 311 and determines that the results (e.g., the performance data for the deployed LLM) are within a predicted performance range (e.g., for the configuration data associated with the deployed LLM). After one quarter, there are potential software and/or hardware changes on the server on which the LLM is deployed, as well as potentially an update to the deployed LLM. During a “quiet” period, the metrics collection process may be repeated (e.g., as a background process), where updated configuration data and performance data are obtained utilizing the LLM configuration collector 303 and the LLM performance executor 305. The LLM performance orchestrator 301 runs this updated configuration data and performance data using the LLM performance prediction models 311. Even though the particular updated configuration is “unseen” and different than the original configuration on which the LLM was deployed, the LLM performance prediction models 311 are able to predict what the performance should or is expected to be. The LLM performance orchestrator 301 reports on any deviations (e.g., performance anomalies) from what would be expected given the updated configuration information, which allows and enables triaging the issue (e.g., performing RCA, possibly rolling back changes, etc.).

The technical solutions described herein enable designing and building of custom performance prediction models for deployed LLMs or other AI/ML models, which are tuned to predict different LLM or other AI/ML performance metrics. Such performance prediction models, in some embodiments, are polynomial regression models, and provide excellent accuracy when predicting the performance of deployed LLMs or other AI/ML models in new unseen configurations. A dataset of performance and configuration data may be built over thousands of tests and millions of data points (e.g., for LLMs or other AI/ML models deployed on IT assets which an enterprise or other entity manufactures, manages or otherwise provides support for). The novel custom performance prediction models, in some embodiments, are integrated into the runtime flow of LLMs or other AI/ML models, providing new visibility into how the LLM or other AI/ML models should or are expected to perform in various production environments. The technical solutions described herein may be offered as a service (e.g., to customers or other users of an enterprise or other entity that manufactures, manages or provides support services for IT assets on which LLMs or other AI/ML models are deployed, for the enterprise or other entity to ensure that LLMs or other AI/ML models deployed on its IT assets or IT assets which it supports or manages are running efficiently, etc.).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated management of configuration drift for machine learning models deployed on IT assets will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphics processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated management of configuration drift for machine learning models deployed on IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to monitor one or more performance metrics associated with execution of a machine learning model deployed on an information technology asset;
to determine configuration information characterizing a current configuration for the information technology asset on which the machine learning model is deployed;
to generate, utilizing one or more performance prediction models that take as input the determined configuration information, one or more predicted performance metrics associated with execution of the machine learning model utilizing the current configuration of the information technology asset;
to determine, utilizing the one or more predicted performance metrics and the monitored one or more performance metrics, whether the execution of the machine learning model deployed on the information technology asset is experiencing a configuration drift-induced performance issue; and
to modify, in response to determining that the execution of the machine learning model deployed on the information technology asset is experiencing the configuration drift-induced performance issue, at least one of (i) the current configuration of the information technology asset and (ii) the machine learning model deployed on the information technology asset.

2. The apparatus of claim 1 wherein the machine learning model comprises a large language model (LLM).

3. The apparatus of claim 2 wherein monitoring the one or more performance metrics associated with execution of the machine learning model deployed on the information technology asset comprises monitoring:
an average input token performance metric characterizing an average number of input tokens for input prompts applied to the machine learning model;
an average output token performance metric characterizing an average number of output tokens for responses output by the machine learning model in response to the input prompts; and
a time to first token metric characterizing an average time taken to return a first output token in the responses output by the machine learning model in response to the input prompts.

4. The apparatus of claim 1 wherein determining the configuration information comprises detecting a current hardware and software configuration of the information technology asset.

5. The apparatus of claim 1 wherein determining the configuration information comprises detecting at least one of a number and a type of graphics processing units of the information technology asset utilized for performing inference using the machine learning model.

6. The apparatus of claim 1 wherein determining the configuration information comprises detecting at least one of a version and a type of machine learning model deployment framework used for executing the machine learning model on the information technology asset.

7. The apparatus of claim 1 wherein the one or more predicted performance metrics comprise:
a throughput metric characterizing an expected throughput associated with execution of the machine learning model utilizing the current configuration of the information technology asset;
a latency metric characterizing an expected latency associated with execution of the machine learning model utilizing the current configuration of the information technology asset; and
a time to first token metric charactering an expected time to first token associated with execution of the machine learning model utilizing the current configuration of the information technology asset.

8. The apparatus of claim 1 wherein determining the configuration information, generating the one or more predicted performance metrics and determining whether the execution of the machine learning model deployed on the information technology asset is experiencing a configuration drift-induced performance issue are performed in response to detecting that at least a threshold amount of time has passed since the machine learning model was first deployed on the information technology asset.

9. The apparatus of claim 1 wherein determining the configuration information, generating the one or more predicted performance metrics and determining whether the execution of the machine learning model deployed on the information technology asset is experiencing a configuration drift-induced performance issue are performed periodically.

10. The apparatus of claim 1 wherein modifying said at least one of (i) the current configuration of the information technology asset and (ii) the machine learning model deployed on the information technology asset comprises:
identifying one or more changes that are potential causes of the configuration drift-induced performance issue; and
rolling back the identified one or more changes to remediate the configuration drift-induced performance issue.

11. The apparatus of claim 10 wherein the identified one or more changes comprise at least one of:
a change in a version of the machine learning model that is deployed on the information technology asset; and
a change in hardware resources of the information technology asset allocated for executing the machine learning model.

12. The apparatus of claim 10 wherein the identified one or more changes comprise at least one of:
a change in software installed on the information technology asset; and
a change in hardware installed in the information technology asset.

13. The apparatus of claim 10 wherein the identified one or more changes comprise a change in an information technology infrastructure environment in which the information technology asset operates.

14. The apparatus of claim 13 wherein the change in the information technology infrastructure environment in which the information technology asset operates comprises a change in at least one of air flow, heating and cooling of the information technology infrastructure environment.

15. A computer program product comprising a non-transitory processor-readable storage medium having stored therein program code of one or more software programs, wherein the program code when executed by at least one processing device causes the at least one processing device:
to monitor one or more performance metrics associated with execution of a machine learning model deployed on an information technology asset;
to determine configuration information characterizing a current configuration for the information technology asset on which the machine learning model is deployed;
to generate, utilizing one or more performance prediction models that take as input the determined configuration information, one or more predicted performance metrics associated with execution of the machine learning model utilizing the current configuration of the information technology asset;
to determine, utilizing the one or more predicted performance metrics and the monitored one or more performance metrics, whether the execution of the machine learning model deployed on the information technology asset is experiencing a configuration drift-induced performance issue; and
to modify, in response to determining that the execution of the machine learning model deployed on the information technology asset is experiencing the configuration drift-induced performance issue, at least one of (i) the current configuration of the information technology asset and (ii) the machine learning model deployed on the information technology asset.

16. The computer program product of claim 15 wherein the machine learning model comprises a large language model (LLM).

17. The computer program product of claim 16 wherein monitoring the one or more performance metrics associated with execution of the machine learning model deployed on the information technology asset comprises monitoring:
an average input token performance metric characterizing an average number of input tokens for input prompts applied to the machine learning model;
an average output token performance metric characterizing an average number of output tokens for responses output by the machine learning model in response to the input prompts; and
a time to first token metric characterizing an average time taken to return a first output token in the responses output by the machine learning model in response to the input prompts.

18. A method comprising:
monitoring one or more performance metrics associated with execution of a machine learning model deployed on an information technology asset;
determining configuration information characterizing a current configuration for the information technology asset on which the machine learning model is deployed;
generating, utilizing one or more performance prediction models that take as input the determined configuration information, one or more predicted performance metrics associated with execution of the machine learning model utilizing the current configuration of the information technology asset;
determining, utilizing the one or more predicted performance metrics and the monitored one or more performance metrics, whether the execution of the machine learning model deployed on the information technology asset is experiencing a configuration drift-induced performance issue; and
modifying, in response to determining that the execution of the machine learning model deployed on the information technology asset is experiencing the configuration drift-induced performance issue, at least one of (i) the current configuration of the information technology asset and (ii) the machine learning model deployed on the information technology asset;
wherein the method is performed by at least one processing device comprising a processor coupled to a memory.

19. The method of claim 18 wherein the machine learning model comprises a large language model (LLM).

20. The method of claim 19 wherein monitoring the one or more performance metrics associated with execution of the machine learning model deployed on the information technology asset comprises monitoring:
an average input token performance metric characterizing an average number of input tokens for input prompts applied to the machine learning model;
an average output token performance metric characterizing an average number of output tokens for responses output by the machine learning model in response to the input prompts; and
a time to first token metric characterizing an average time taken to return a first output token in the responses output by the machine learning model in response to the input prompts.
